(19) United States
(12) Patent Application Publication
(10) Pub. No.: US 2013/0080949 A1
(43) Pub. Date: Mar. 28, 2013

(54) USER INTERACTIONS

(71) Applicant: Red Eye International Ltd., Cheshire (GB)

(72) Inventors: Chris Gibbins, Cheshire (GB); Garry Lee, Cheshire (GB); Mark Patron, Cheshire (GB)

(73) Assignee: RED EYE INTERNATIONAL LTD., Cheshire (GB)

(21) Appl. No.: 13/626,234

(22) Filed: Sep. 25, 2012

(30) Foreign Application Priority Data
Sep. 27, 2011 (GB) 1116638.6

(51) Int. Cl. G06F 3/048

(52) U.S. Cl. 715/764

(57) ABSTRACT

Computer implemented methods, apparatus and software for use in improving user interactions with a user interface provided by a data resource. The data resource provides an interaction sequence during a user interaction including a plurality of steps with the user interface. Interaction data indicative of user interactions provided by the data resource is determined. The interaction data includes resource data indicative of a respective interaction sequence of said different interaction sequences, and a respective step of said plurality of steps included in said respective interaction sequence, and user data. User interactions are assigned to predefined categories based on the user data. A plurality of analytics values are determined based on the resource data and the assigned categories, such that the determined analytics values are associated with a given category, interaction sequence and step, the analytics values being for use in improving user interactions with the user interface.

### FIELD OF THE INVENTION

The present invention relates to systems and methods for improving user interactions and in particular to systems and methods for improving user interactions with a user interface of a computer system, such as a graphical user interface.

### BACKGROUND

A user interface enables a human (generally known as a user in these contexts) to interact with a computer or computing system. A user interface can take many forms, and provide interaction with a user through any, or a combination of, the five senses, the most common senses used being sight and sound,

User interfaces are presented in many contexts. Examples may include: a series of webpages viewed using a browser; a series of windows presented by an application running on a desktop computer; and a series of screens presented by an ‘app’ running on a ‘smartphone’. Collectively, such visual interfaces are termed graphical user interfaces.

Many user interfaces operate in a similar logical fashion. In a given user interaction, a user is provided with information in a series of interactive steps. At each of the interactive steps, the user provides user input (often in response to the provided information) which controls when and how the subsequent steps are provided to the user. The steps are linked in an interaction sequence (also known as a “journey”). Any given interaction sequence generally has a goal (for example, retrieving desired information, or completing a questionnaire), and therefore the nature of the steps, if not the instance specific content, is to some extent predetermined.

In any given system (i.e. website or application) many different interaction sequences, each enabling a different result to be achieved, may be provided. Therefore, in any given session, a user may undertake (or partially undertake) many different interaction sequences; each undertaking being termed a user interaction.

As an example, a website may offer information on train services. For this website, a first interaction sequence may enable a user to locate their local station, while a second interaction sequence may enable a user to find specific train times. The provision of this second interaction sequence to a user in a given user interaction may involve the following steps:

1—a first webpage is provided requesting identification of start and end stations;

2—the user enters the required details, and selects “search”;

3—a second webpage is provided requesting further details of the desired train journey (i.e. times, dates, whether changes are acceptable to the user etc.);

4—the user provides input specifying these further details;

5—a third webpage is provided listing possible train times which fit the conditions specified by the user.

The above process (to the extent described) is a three step interaction sequence, comprising the steps of initial search entry, detailed search entry, and train listings. This sequence may be followed many times in different user interactions (often by different users), each user interaction involving different search terms. Nevertheless, in all cases the same sequence will be followed, with only the detail changing.

In some cases a user may experience difficulties in the interaction sequence. The nature of such difficulties may be highly varied, and may result from a user being unable to easily digest the information provided in a particular step, to the user being frustrated in entering information (i.e. user input) in a step. Such difficulties often result in a user not completing the interaction sequence, and therefore not achieving the intended result (e.g. receiving a listing of train times).

Therefore, there is a need for systems and methods which identify such difficulties so that improvements may be made to the user interface. This enables improved user interfaces to be constructed and therefore adds to the efficiency of computer systems as a whole.

### SUMMARY OF THE INVENTION

In accordance with at least one embodiment, methods, devices, systems and software are provided for supporting or implementing functionality to provide for the improvement of user interactions.

This is achieved by a combination of features recited in each independent claim. Accordingly, dependent claims prescribe further detailed implementations of the present invention.

According to a first aspect there is provided a computer implemented method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising: determining interaction data indicative of user interactions provided by the data resource, the interaction data including resource data indicative of a respective interaction sequence, of said different interaction sequences, and a respective step, of said plurality of steps, included in said respective interaction sequence, and user data; assigning user interactions to predefined categories based on the user data; and determining a plurality of analytics values based on the resource data and the assigned categories, such that the determined analytics values are associated with a given category, interaction sequence and step, the analytics values being for use in improving user interactions with the user interface.

According to a second aspect, there is provided a system for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the system comprising a processor configured to: determine interaction data indicative of user interactions provided by the data resource, the interaction data including resource data indicative of a respective interaction sequence, of said different interaction sequences, and a respective step, of said plurality of steps, included in said respective interaction sequence, and user data; assign user interactions to predefined categories based on the user data; and determine a plurality of analytics values based on the resource data and the assigned categories, such that the determined analytics values are associated with a given category, interaction sequence and step, the analytics values being for use in improving user interactions with the user interface.

According to a third aspect, there is provided a computer program product comprising a non-transitory computer-readable storage medium having computer readable instructions stored thereon, the computer readable instructions being executable by a computerized device to cause the computerized device to perform a method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising: determining interaction data indicative of user interactions provided by the data resource, the interaction data including resource data indicative of a respective interaction sequence, of said different interaction sequences, and a respective step, of said plurality of steps, included in said respective interaction sequence, and user data; assigning user interactions to predefined categories based on the user data; and determining a plurality of analytics values based on the resource data and the assigned categories, such that the determined analytics values are associated with a given category, interaction sequence and step, the analytics values being for use in improving user interactions with the user interface.

Further features and advantages will become apparent from the following description of preferred embodiments, given by way of example only, which is made with reference to the accompanying drawings.

### BRIEF DESCRIPTION OF THE DRAWINGS

A computer system will now be described as an embodiment of the present invention, by way of example only, with reference to the accompanying figures in which:

FIG. 1 shows a schematic diagram of a computer system in which embodiments may operate;

FIG. 2 shows a sequence of steps which may be provided as a part of a user interaction;

FIG. 3 shows a series of data records as may describe user interactions in an embodiment;

FIG. 4 shows how analytics values according to embodiments may be calculated;

FIG. 5 shows a plurality of analytics values as might be calculated in an embodiment; and

FIG. 6 shows a method according to an embodiment.

### DETAILED DESCRIPTION OF ILLUSTRATIVE EMBODIMENTS

Prior to a detailed description of embodiments referencing the Figures, some embodiments will be described in summary form.

According to a first embodiment there is provided a computer implemented method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising: determining interaction data indicative of user interactions provided by the data resource, the interaction data including resource data indicative of a respective interaction sequence, of said different interaction sequences, and a respective step, of said plurality of steps, included in said respective interaction sequence, and user data; assigning user interactions to predefined categories based on the user data; and determining a plurality of analytics values based on the resource data and the assigned categories, such that the determined analytics values are associated with a given category, interaction sequence and step, the analytics values being for use in improving user interactions with the user interface.

By determining the analytics values so that they are associated with a given category, interaction sequence and step embodiments are able to identify difficulties in the user interactions with the user interface which would otherwise not be apparent. As will be described below, embodiments create three axes matrices for a given user interface, the cells of which may be analysed individually or in combination. It has been found by the inventors that many difficulties present in user interactions which are not apparent using alternative analytics techniques are made apparent in embodiments, thereby enabling the improvement of user interactions considerably.

The user interface may comprise a graphical user interface. For at least one user interaction, only some of the steps of an interaction sequence may be provided by the data resource, and for at least one further user interaction, all of the steps of an interaction sequence may be provided by the data resource.

Therefore, advantageously, embodiments may identify steps in the user interface which are causing users to abandon user interactions prior to completion, i.e. prior to arriving at a useful result.

The computer implemented method may comprise identifying, for a given category, interaction sequence and step, a number of user interactions of the given category for which the given step of the given interaction sequence was the last step provided in the user interaction, whereby to determine the analytics value associated with the given category, interaction sequence and step.

The number of user interactions of the given category for which the given step of the given interaction sequence was the last step provided in the user interaction is indicative of an abandonment number, i.e. the number of user interactions which were abandoned by the user during or after that particular step.

The computer implemented method may comprise identifying, for a given category, interaction sequence and step, a number of user interactions of the given category for which the given step of the given interaction sequence was followed by at least one further step of the given interaction sequence, whereby to determine the analytics value associated with the given category, interaction sequence and step.

The number of user interactions of the given category for which the given step of the given interaction sequence was followed by at least one further step of the given interaction sequence is indicative of a continuation number, i.e. the number of user interactions which continued from the step in question to at least one further step. The computer implemented method may comprise identifying, for a given category, interaction sequence and step, a ratio of a number of user interactions of the given category for which the given step of the given interaction sequence was the last step provided in the user interaction, to a number of user interactions of the given category for which the given step of the given interaction sequence was followed by at least one further step of the given interaction sequence, whereby to determine the analytics value associated with the given category, interaction sequence and step.

By calculating the ratio, embodiments of the present invention are able to identify a value which provides an indication of the number of improved user interactions which may be enabled by improving a particular step in the user interaction sequence.

The computer implemented method may comprise classifying user interactions as successful or unsuccessful based on the steps provided in the user interaction. The computer implemented method may comprise identifying, for a given category and interaction sequence, a benefit value associated with the user interactions classified as successful. The benefit value may be based on one or more of: a number of successful user interactions; revenue generated by the successful user interactions; input provided by a user during a successful user interaction. The computer implemented method may comprise multiplying the ratio by the benefit value.

By identifying a benefit value (which may simply be the number of user interactions which were completed, i.e. arrived at a useful or desired result), the method used in embodiments may identify which steps in the user interface are most appropriate to improve to provide the greatest benefit to the users. The benefit value may be calculated based on category and interaction sequence. In other words, any given combination of category and interaction sequence will have a distinct benefit value.

The categories may be defined based characteristics of the user and/or a system used by the user to interact with the user interface. The categories may be defined based on one or a combination of: whether the user is a returning user or a new user; location information relating to the user; demographic information relating to the user; a browsing history of the user; a usage history of the user; a time at which the user interaction occurred; computer software used by the user; and computer hardware used by the user.

By classifying the user interactions based on a number of categories, embodiments are able to identify difficulties in user interactions which only affect certain categories. For example, a problem may only surface on a particular browser. Equally, aspects of the user may be used, such as whether they are returning to the website, thus difficulties which only affect new users may be identified.

At least one of the steps may be present in two or more interaction sequences. At least one given user may make a plurality of said user interactions in a given session.

The computer implemented method may comprise comparing the analytics values and identifying at least one of the steps of an interaction sequence associated with a given category based on the magnitude of the associated analytics values.

In certain embodiments, the analytics values can be analysed to identify the largest one (or ones). These values may be used to target improvements to the user interface, such that the greatest user benefit is provided.

The computer implemented method may comprise: receiving a modification proposal, the modification proposal identifying one or more of said steps of one or more interaction sequences associated with one or more of said categories; calculating a combined analytics value based on the analytics values associated with the identified one or more steps, one or more interaction sequences and one or more categories.

Advantageously, multiple analytics values may be combined using a modification proposal. This enables a single modification with effects throughout the website to be analysed for effectiveness, and consequently the expected benefit of any changes will be more accurately determined.

The computer implemented method may comprise: receiving a modification value associated with the modification proposal; multiplying the combined analytics value by the modification value.

Advantageously a modification value may be provided with the modification proposal. This may be an indication of the difficulty of implementing the modification proposed in the modification proposal, or a value indicative of the relative benefit of the proposal. This enables a more accurate comparison of various modifications to be provided in some embodiments.

The user interface provided by the data resource may comprise a website provided by a server, and said steps may comprise webpages generated using data provided by the server.

According to a second embodiment, there is provided a system for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the system comprising a processor configured to: determine interaction data indicative of user interactions provided by the data resource, the interaction data including resource data indicative of a respective interaction sequence, of said different interaction sequences, and a respective step, of said plurality of steps, included in said respective interaction sequence, and user data; assign user interactions to predefined categories based on the user data; and determine a plurality of analytics values based on the resource data and the assigned categories, such that the determined analytics values are associated with a given category, interaction sequence and step, the analytics values being for use in improving user interactions with the user interface.

According to a third embodiment, there is provided a computer program product comprising a non-transitory computer-readable storage medium having computer readable instructions stored thereon, the computer readable instructions being executable by a computerized device to cause the computerized device to perform a method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising: determining interaction data indicative of user interactions provided by the data resource, the interaction data including resource data indicative of a respective interaction sequence, of said different interaction sequences, and a respective step, of said plurality of steps, included in said respective interaction sequence, and user data; assigning user interactions to predefined categories based on the user data; and determining a plurality of analytics values based on the resource data and the assigned categories, such that the determined analytics values are associated with a given category, interaction sequence and step, the analytics values being for use in improving user interactions with the user interface.

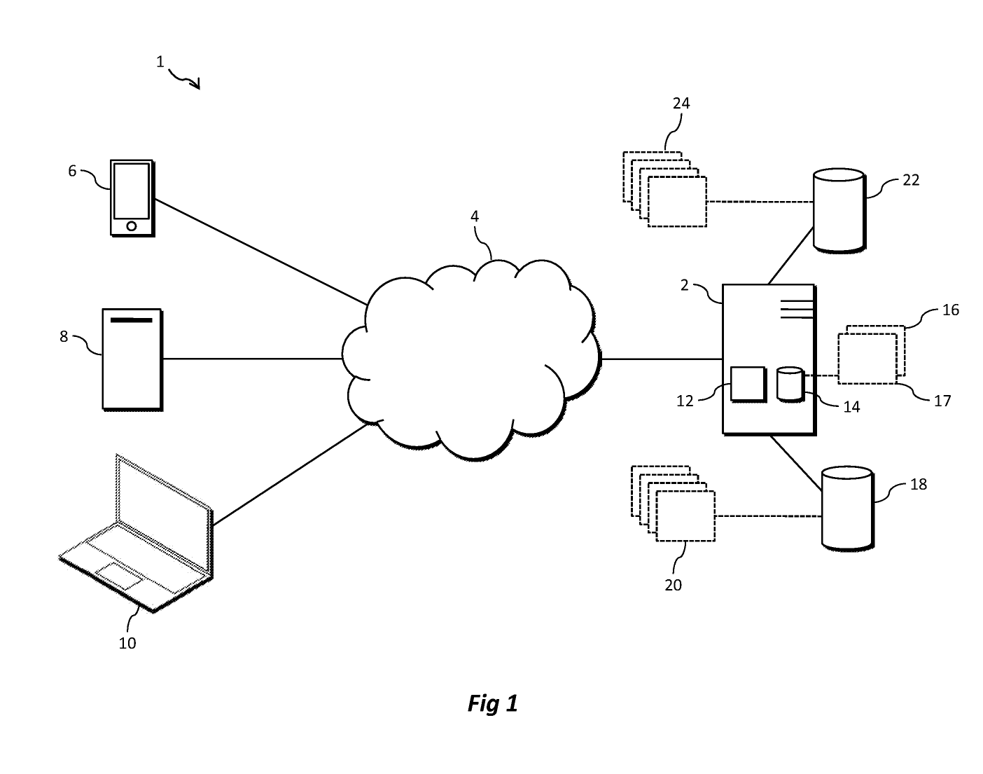

FIG. 1 shows a schematic diagram of a computer system 1, in which embodiments may be used. In the computer system 1, a server 2 is connected through a network 4 to user equipment 6, 8 and 10. Schematically this user equipment is shown as mobile phone (smartphone) 6, desktop computer 8 and laptop computer 10; however it will be understood that any appropriate user equipment may be used. This exemplary embodiment will be described in the context of a website, therefore the user equipment are provided with a network interface (to send and receive data), memory and a processor as are well known in the art. A browser application may be stored in the memory and executed by the processor to enable the ‘surfing’ on the internet and the accessing of any given website.

The server system 2 contains one or more storage and processing elements, schematically, these elements are represented by processor 12 and memory 14. The memory 14 stores software components 16 and 17 containing processing instructions which are executed by the processor 12 to perform the functions of the server. In this example, the software components include webserver software component 16 which enable the server to provide a webserver functionality (i.e. receiving HTTP requests and providing webpages as responses) to enable user interactions, and analysis software components 17 which enable the server to analyse these user interactions. Both will be described in more detail below.

The server system 2 is further connected to two databases. The first database 18 contains data/content 20 which may be provided by the server system 2 to the user equipment 6, 8 and 10 to enable user interactions. In this example, this content comprises webpages, which may contain static HTML, active content (e.g. content generated using JavaScript, Flash or similar), multimedia content (e.g. video and audio clips), server generated content (e.g. PHP or ASP pages) or a combination thereof. The second database 22 stores records 24 containing information on user interactions. This information is provided by the server 2 during or after the user interactions, and is later retrieved by the server to be analysed.

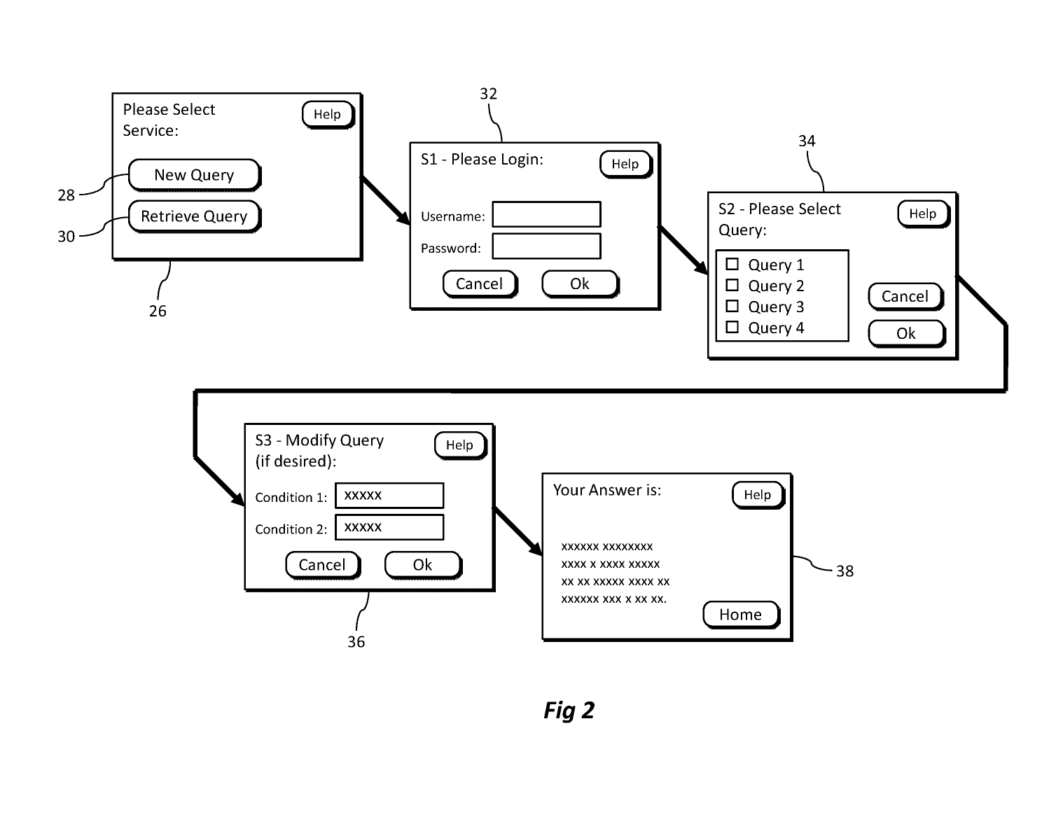

The operation of the system 1 described above in providing a user interaction will now be described with reference to FIG. 2. FIG. 2 shows example screens or webpages which may be provided in a sequence of steps to a user during a user interaction. The webpages shown in FIG. 2 are simplifications, and are not intended to be descriptive or limiting in any way.

In a preliminary stage a user operating user equipment (e.g. laptop 10) accesses a website provided by the server 2. This, as is known in the art, may be done by the user entering a URL into a web browser, or by the user locating the website through a search engine. The user equipment sends a request (e.g. an HTTP request) through the network 4 to the server 2. The request identifies the website, typically by its domain name (i.e. www.somedomain.com).

In response to the request, the server 2 identifies the appropriate webpage stored as content 20 in the database 18. This content is retrieved, and sent back to the user equipment according to methods well known in the art. The server may optionally modify or dynamically create any portion of the content sent to the user equipment as is also known in the art.

The content is received from the server 2 and displayed on the screen of the user equipment (e.g. laptop 10) as home screen 26. The home screen may not itself be part of a specific user interaction sequence, but provides a launch page to access one of a number of interaction sequences. In this example, links 28 and 30 allow the user to access two different user interaction sequences, the first being a new query, the second being the retrieval and repeating of an old query. The user clicks on one or other of the links, to access the respective interaction sequence. In this example, the user is assumed to click on the “Retrieve Query” link 30, to access the retrieved query interaction sequence.

The user equipment 10 then sends an appropriate request (e.g. an HTTP request) to the server 2 via network 4, the request identifying that the “Retrieve Query” link 30 was selected. The server 2, in response, retrieves the appropriate webpage from database 18 and sends the same to the user equipment 10.

In this example, this first step of the “Retrieve Query” interaction sequence is the provision of login page 32, which enables users to identify themselves so as to be able to retrieve previous queries. This page is received by the user equipment and displayed to the user. The user subsequently provides user input, that of his/her login details, and selects OK. The response is again transmitted from the user equipment to the server 2.

The server 2 then checks the login details against data stored in database 18 (it will be assumed that the details are correct). Subsequently, in the second step of the interaction sequence, the server 2 provides content 34 which presents a screen enabling a user to select one of a plurality of existing queries. The user provides further user input, that of selecting one of the queries, and clicking OK. The user equipment then transmits a message to the server, identifying the selected query.

The third step of the interaction sequence is then provided, in this case a webpage 36 allowing the user to modify the query. The webpage contains input elements which enable a user to provide user input to modify the query (the elements are shown being populated with the conditions from the retrieved query). Once again, the user provides input (which in this case may simply be the clicking of the OK button) causing an appropriate message to be transmitted to the server 2.

The fourth step of the interaction sequence is subsequently provided as an answer page 38. This step marks the end of the interaction sequence, and in particular a complete interaction sequence. It will be apparent that this last step, in ending the interaction sequence and in contrast to the previous steps, may not request user input. Nevertheless, in some cases the last page may offers the opportunity for a user to access further interaction sequences; therefore, as shown, the last step provides a “Home” link, enabling the user to commence a new interaction sequence. The user may select the home button and begin a new query, which would involve a new (and potentially different) interaction sequence and would be classified as a new user interaction.

Therefore, each interaction sequence comprises one or more interactive steps, in response to which user input may be provided. Upon receipt of appropriate user input the system (i.e. user equipment 10 and server 2) may present the user with further (interactive) steps in the sequence. At the end of an interaction sequence, a final step is provided which may not be interactive, in that it may not request user input. The provision of this last step may be associated with a completed interaction sequence.

It will be understood that the above is a purely exemplary description of an interaction sequence. The above process may be repeated with many different users (and multiple times with the same user). Moreover, while the above describes a complete interaction sequence, by contrast, in some user interactions (i.e. visits to the website by the same or a different user) a user may abandon the user interaction part of the way through. For example, having received, in step 3, the modify query page, the user may not click OK, and may simply abandon the website (i.e. by clicking cancel, surfing to a further website or closing their browser). Since the user never reached the answer step (step 4) in the interaction sequence, that particular user interaction would be incomplete. As mentioned above, incomplete user interactions represent a problem.

In some user interactions, the user may select the new query button 28. This will lead to a different interaction sequence which will be referred to below, but not described in detail herein. Alternatively, again as will be noted below, a user may arrive at a page of the website from an external source. The resulting, third, interaction sequence may similarly involve a different interaction sequence to the new and repeat query interaction sequences mentioned above, and may, for example, involve the query conditions being provided by the external source.

In accordance with embodiments, a record is kept of the user interactions with the website, and in particular whether the interaction was complete, or incomplete. If the interaction was incomplete, the record may specify which step was the last performed. This data may be collected by the server 2 running the webserver software components 16, and stored as records 24 in database 22. Further data, relating to the interaction, may also be collected. This further data may be used to categorise the user interactions as will be described below.

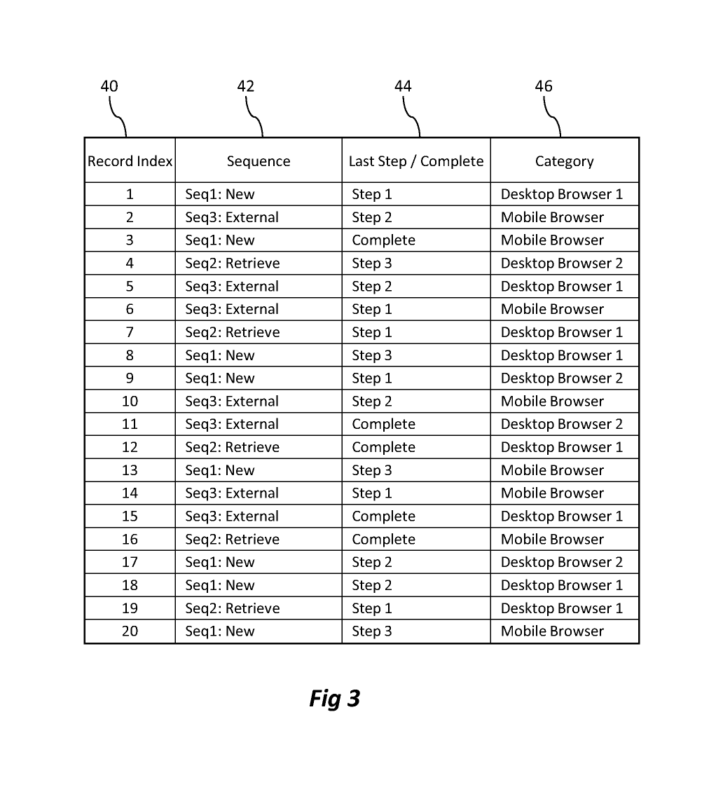

FIG. 3 shows a table of such records 24 as may be stored in database 22. In general the data stored in the database 22 may be web analytics data; nevertheless, an example form of such data will be described with reference to FIG. 3. The first field 40 in the database stores a record index. The second field 42 stores an identifier of the interaction sequence which was being followed by a user, in this case one of “Seq1: New” indicating a new query was being made, “Seq2: Retrieve” meaning that a repeated query was being retrieved and made, and “Seq3: External” meaning that the interaction sequence was initiated by an external component (as mentioned above). The third field, 44 specifies whether the interaction sequence was completed, or whether it was abandoned (and if so, at what step). Finally the fourth field 46 specifies a category for the user interaction. In this example, the category is defined based on the browser used by the user when accessing the website. This field can take one of three values, “Desktop Browser1”, “Desktop Browser 2” and “Mobile Browser”. Such information may be available from the HTTP requests sent by the user equipment. It will be apparent that other categorisations may be used, some examples of which will be described below.

The table of FIG. 3 shows only a sample of the data as it might be stored, and it will be apparent that many more entries will typically exist in the database 22. It will further be apparent that while the table shown in FIG. 3 provides descriptive data (i.e. Seq1: New), when the data is stored, any given interaction sequence, page or category may simply be given an index, such as a number. Therefore, henceforth, all interaction sequences, categories and steps will simply be indexed by integers, for example as “Category 1”.

The above description provides an example of how user interactions (i.e. visits to websites) may be provided and logged by server 2. Below, a method of analysing the data in accordance with an embodiment will be described. This method may be performed by server 2 running software components 17.

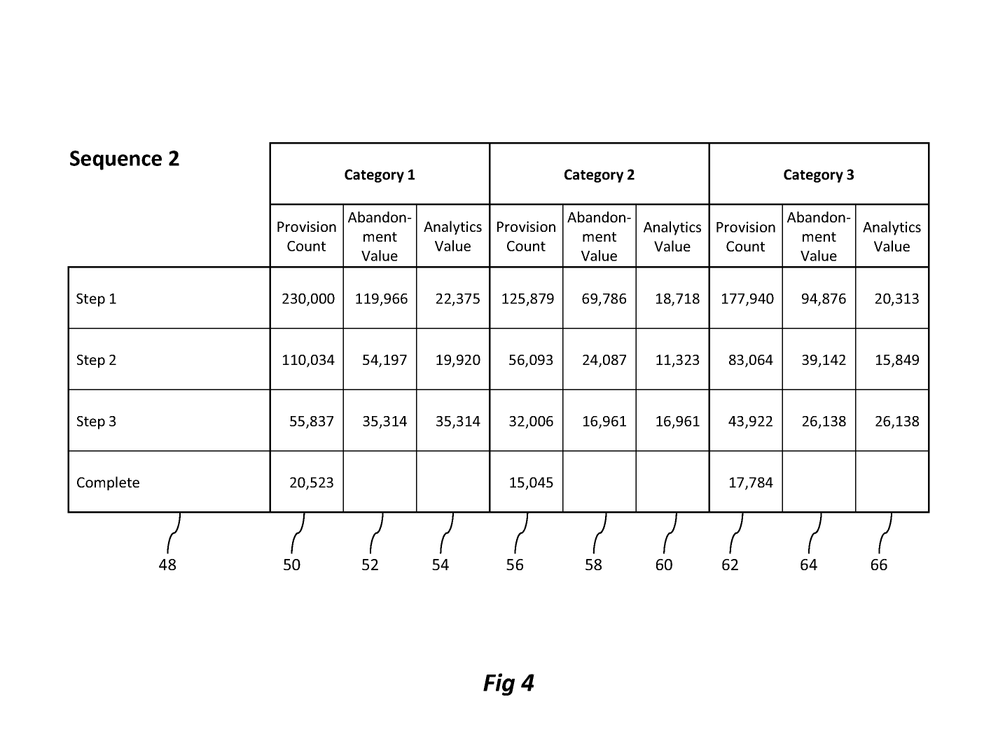

In this embodiment, analytics values (which may also be known as optimisation values) are calculated based on the data records for each user interaction (or visit). This is done by analysing the steps of the interaction sequences to determine whether that step was the last in the sequence (or not) and to what category the user interaction belonged. An example of the output of such analysis is shown in FIG. 4.

The table in FIG. 4 shows the calculations for interaction sequence 2. In this sequence there were three interactive steps (i.e. pages presented to the user requesting user input), and the final step in which the answer was provided. This sequence excludes the home page 26. One row exists for each of the interactive steps, these rows labelled, “Step 1”; “Step 2”; and “Step 3”. A further row exists for the finishing step, marked “Complete”. The row headings are provided in column 48.

Against each of these steps, data is provided subdivided by the category of the particular user interaction, in this case “Category 1”; “Category 2”; and “Category 3”.

An analytics value is calculated for each combination of interactive step and category in the selected interaction sequence. To calculate the analytics value, the server first identifies the provision count for each step/category combination, this being the number of distinct user interactions in that category for which that step was provided by the server 2. This provision count is presented in columns 50, 56 and 62.

In the case of the category 1, the step 1 was provided in 230,000 separate user interactions. However, the step 2 was provided in only 110,034 user interactions, indicating that a number of users who had started along the interaction sequence did not provide a user input in response to the step 1, and therefore did not proceed to step 2. Similar analysis can be performed for each step including the final step (the answer page). In this example, the final step was provided in 20,523 different user interactions, meaning that 20,523 distinct user interactions were completed. Provision count data is also identified for the other combinations of step and category, and presented in columns 56 and 62.

It will be apparent that the 110,034 provisions of step 2 (in category 1) were all preceded by a provision of step 1. Therefore, for each step, an abandonment value, indicating the number of user interactions for which that step was the last step, can be calculated by subtracting the provision count for the next step from the provision count for the given step. Therefore for step 1, the abandonment count is 119,966, which is calculated by subtracting 110,034 from 230,000. The same analysis can be performed for each interactive step, in each category (i.e. for all of columns 52, 58 and 64). It will be apparent that an abandonment value does not have to be calculated for the final step, since the provision of this step indicates a complete interaction sequence, and therefore it does not affect the analysis of that interaction sequence whether the user continued to surf the website after being provided with the final step. In some embodiments, the number of users commencing a different interaction sequence after being provided with the final step may be analysed, however this will not form a part of the current example.

In some embodiments, the abandonment value may be taken directly as the analytics value. However in this embodiment the server 2 will process the values further to arrive at the analytics values presented in column 54, 60 and 66.

To calculate these analytics values, the number of completed interaction sequences in that category is multiplied by the ratio of the abandonment value to a completion value (which is the provision count of the next step, or alternatively the difference between the abandonment value and the provision count). Therefore, the analytics value represents the expected increase in completed user interactions which might be achieved by a fractional reduction in the number of user interactions abandoned at that step. For instance, if a 5% reduction in abandonment was achieved for the modify step (step 3), then 5%×35,314≈1766 more complete user interactions might be expected.

An analytics value may correspondingly be calculated for all the categories and steps of the interaction sequence, as shown in columns 54, 60 and 66 in FIG. 4 (excluding the final step, for which an analytics value would not be relevant to the analysis). Equally, by a similar process, an analytics value may be calculated for the steps and categories of the other interaction sequences.

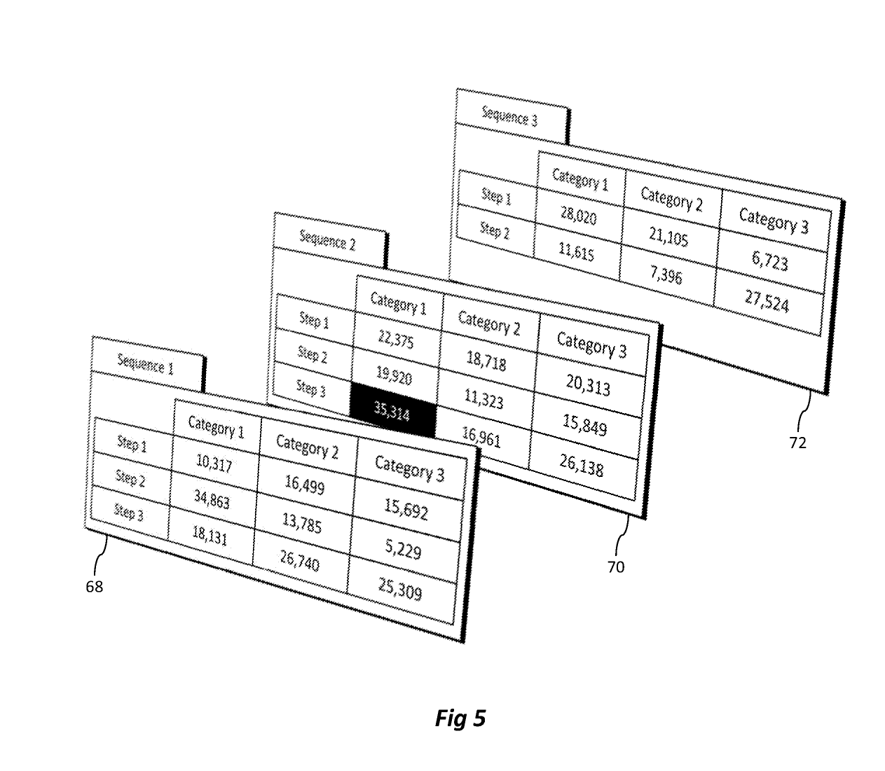

FIG. 5 shows the results of such analysis in a pictoral format. For each of the three interaction sequences, represented by ‘cards’ 68, 70 and 72 an analytics value has been calculated for the combinations of category and interactive step. As is apparent the other interaction sequences (1 and 3) comprise different steps to sequence 2 described in detail above. Moreover, Sequence 3 has only two interactive steps.

It will be apparent that each value represents an entry in a three dimensional matrix of values, with the axes of the matrix representing a category index, step index and interaction sequence index. Therefore each entry in the matrix may be indexed as A_{i,j,k}. where i is the sequence index, j is category index, and k is step index.

Each entry in the matrix A may be represented by the formula

$${A}_{i , j , k} = {C}_{i , j} \frac{( {p}_{i , j , k} - {p}_{i , j , k + 1} )}{{p}_{i , j , k + 1}}$$

where:

C_{i,j} is the completion count, i.e. the number of user interactions which completed the i^{th} interaction sequence and were categorised in the j^{th} category; and

p_{i,j,k} is the provision count, i.e. the number of user interactions in the j^{th} category for which the k^{th} step in the i^{th} interaction sequence was provided (irrespective of whether the step was the last). It will be apparent that p_{i,j, k+1} is the provision count for the next step, i.e. the continuation count for the current step, and that (p_{i,j,k}−p_{i,j,k+1}) is the abandonment count for the current step.

The matrix may subsequently be analysed to identify steps in the interaction sequences which would appear to be causing difficulties. For example, the matrix may be analysed to identify the combination or combinations (of indexes) of step, interaction sequence and category which would provide the greatest user benefit if the difficulties were addressed. In FIG. 5 this combination of indexes is represented as the black box in the “Sequence 2” card, Category 1, Step 3 for which the analytics value of 35,314 is the highest. In other words, A_{2,1,3}=35,314.

However more complex analysis may be performed. For instance, a modification matrix may be generated, which is itself a further three dimensional matrix of values indicating an expected benefit of a modification to the website. Each value in this matrix may be based on an expected impact a modification will make to the corresponding step, category and interaction sequence. Therefore, this matrix may similarly be indexed as M_{i,j,k}. The matrix may have a simple format, wherein one or more cells in the matrix have the value 1, and the rest have the value 0. Alternatively, the modification matrix may contain a fractional expected improvement fraction for one or more cells, and 0 for the remainder. The matrix may be provided by an analysis, based on knowledge of the website, and a preliminary analysis of the matrix A.

Having generated a modification matrix, the analysis matrix A and the modification matrix M may be combined to calculate a modification value for that modification. This overall value may be represented as:

$${\sum }_{∀ i , j , k} ( {A}_{i , j , k} \cdot {M}_{i , j , k} )$$

The overall values for a plurality of modifications can subsequently be compared to identify the modification(s) providing the greatest user benefit.

To provide in-context examples, a first modification may be to improve the readability of step 3 (modify) for mobile browsers. The modification matrix for this modification may have the value 0.1 in the cell representing sequence 2 (retrieve), step 3 (modify), category 1 (mobile), and zero in every other cell. That is:

$${M}_{i , j , k} = \{ \begin{matrix}0.1 & i = 2 , j = 1 , k = 3 \\ 0 & otherwise\end{matrix}$$

This represents the scenario that a modification here would benefit only that particular step, in that particular sequence for that particular category by an expected reduction of 10% in abandonment. Consequently the modification value for that modification would be 0.1×35,314=3,531.4.

A second modification might be to provide a prominent forgotten password link for step 1 (login) of sequence 2 (retrieve) across all categories. Therefore the modification matrix may have the values of 0.05 in all three cells corresponding to step 1 of sequence 2, and any of category 1, 2 or 3; the value of 0.05 representing a 5% reduction in abandonment. The modification matrix would therefore take the form:

$${M}_{i , j , k} = \{ \begin{matrix}0.05 & i = 2 , k = 1 , j = 1 , 2 , 3 \\ 0 & otherwise\end{matrix}$$

The resulting overall value would be 0.05×(22,375+18,718+20,313)=3070.3.

Therefore, it can be seen that the first modification would benefit a greater number of users than the second, despite only affecting a single step of a single sequence in a single category. Therefore this embodiment enables analysis of modifications to be performed such that the greatest user benefit is provided.

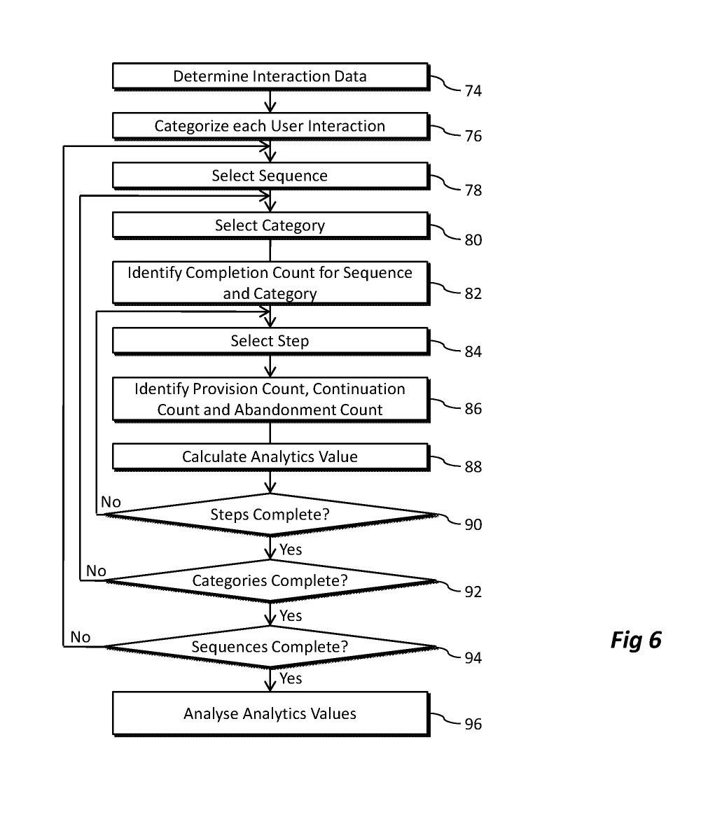

A generalised method of generating the matrix of analytics values A will now be described with reference to FIG. 6. This method may be performed by the processor 12, executing software components 17 stored in memory 14.

In a first step 74, the processor 12 determines interaction data indicative of the user interactions provided to users. This may involve retrieving the records 24 from database 22.

In a second step 76, the processor 14 categorises each user interaction. This may be done based on the browser used in the user interaction as described in the example above. The categorisation may be performed using predetermined categories. Having categorized the user interactions, in step 78, the processor 12 selects an interaction sequence and, in step 80, a category.

Having selected a category and interaction sequence, in step 82, the processor 12 identifies a completion count for the selected sequence and category. The completion count, as described above, represents the number of user interactions of the selected sequence and category, which were completed (C_{i,j} in the equations above).

Subsequently, in step 84, the processor selects a step and, in step 86 identifies the provision count for that step, along with the continuation count and abandonment count. As described above, the provision count represents the number of user interactions of the selected sequence and category for which the selected step was provided (p_{i,j,k} in the equation above).

The continuation count represents the number of user interactions of the selected sequence and category for which a subsequent step in the interaction sequence was provided (p_{i,j,k+1} in the equation above).

The abandonment count represents the number of user interactions of the selected sequence and category for the selected step was the last step provided in the associated user interaction (p_{i,jk}−p_{i,j,k+1} in the equation above).

From these count values, in step 88, the processor calculates an analytics value for the selected step, category and sequence. This may be done by multiplying the completion count by the ratio of the continuation count and the abandonment count.

Subsequently, in step 90, the processor determines whether all the steps of the interaction sequence have had an analytics value calculated for them. If not, the process returns to step 84, in which a further step is selected, and in steps 86 and 88 an analytics value is calculated for the further selected step (but same category and sequence). This loop repeats until all the steps in the sequence have had analytics values calculated for them.

Then, in step 92, the server determines whether all the categories (and all the steps in the categories) have been analysed. If not, then process returns to step 80 in which a further category is selected, and all the steps in that loop are analysed.

A final loop, represented by decision block 94 returning to step 78 is then used to select the other interaction sequences to be analysed as described above for the first sequence.

Finally, having calculated an analytics value for all of the steps in all of the sequences, for all of the categories, in step 96 the analytics values may be analysed. The analysis, as described above, may include looking for the largest analytics value(s). Alternatively, the analysis may include generating a modification matrix, and using the analytics values and the modification matrix to identify beneficial modifications.

### Additional Details and Modifications

The analytics value calculated above was calculated based on the number of user interactions which were completed. However in alternative embodiments, alternative values may be used. For example, each completed user interaction may be provided with a benefit value. This value may be based on a number of factors, including the user interaction specific data provided during or after the user interaction. This data may be user input (such as a rating provided by a user) or generated by the server in response to the user input. The benefit value may be specific to a given category or interaction sequence or combination of the two.

This benefit value may be substituted for the corresponding completion count in the equations above. The analytics values may therefore be calculated based on the product of the benefit value for the particular interaction sequence and category and the ratio of continuation count to abandonment count. Therefore, the analytics value will represent an expected change in the benefit value for a fractional decrease in the proportion of abandoned interaction sequences at a given step.

In one embodiment, the benefit value may be based on revenue gained from the interaction sequence. As such, the interaction sequence may represent a process for buying or selling something (including, e.g. the steps of specifying a product, receiving a quote, and purchasing the product based on the quote including all security measures).

Consequently, the benefit value may be calculated as the total revenue gained through all the user interactions of a given sequence and category. In such scenarios, the analytics value will represent an expected change in revenue for a fractional decrease in the proportion of abandoned interaction sequences at a given step. Therefore the analytics value can be used to target modifications to the website to provide the greatest increase in revenue.

In the above examples, the values taken by the modification matrix were 0.05 and 0.1, indicating an expected 5% and 10% decrease in abandonment respectively. However it will be apparent that any suitable value may be used. For example, any percentage value in the range of 1% to 100% may be used. In exemplary embodiments any integer percentage value from 1% to 10% may be used.

In the above examples, the browser used for a user interaction formed the basis for the categorisation. However, many alternative criteria may be used to categorize the user interactions. In general, the categories are based around aspects of the user equipment used in the interaction or the users themselves. A non limiting set of examples would include:

Whether the user had used the website before, or was a new user. This might be determined using cookies; address information of the user (i.e. an IP or MAC address); or whether the user had registered with the website.

The location of the user equipment being used in the user interaction. This may be determined from the IP address, or by using location information from a mobile device, as is known in the art.

Demographic information relating to the user. The user may create a profile when interacting with the website. The information in such a profile may include age, gender, occupation, likes, dislikes, skills, residency, known languages, and any other demographic information which may be apparent to the skilled person.

The browsing history or usage history of the user or user equipment, this may include which pages of a website a user has visited, the frequency of visits to the website or to specific pages or sequences of pages in the website, a time delay between visits to the website, or to specific pages or sequences (i.e. the latency of activity), what products a user has purchased and how frequently such purchases have been made, and a total value or benefit (i.e. revenue) acquired from the user.

A time at which the user interaction occurred. This time may be local time (for the user) or a generalised time (i.e. UCT). The time may be used to categorise the user interactions to people at work and people at home (the latter performing user interactions in e.g. the evening).

Computer software used by the user, as in the example above, this may be the browser being used on the user equipment, however this may also include the operating system operating on the user equipment, and whether any subsidiary software is installed (such as plugins).

Computer hardware used by the user, the browsing may be performed using a laptop, desktop computer, tablet, PDA or smartphone (amongst other user equipment). As such processing power, resolution of a screen, memory and other hardware aspects of the user equipment may change. The categorisation may take this into account.

The webpages described above are only one example of how a user interface may be provided to a user. Alternatives include applications running on desktop computers, laptops, mobile phones, PDAs, tablet computer or the like. In such scenarios, the server may not provide the individual steps, but instead the application, running locally on the user equipment may determine which steps of a given sequence are to be provided. In such cases the applications may occasionally contact the server for updated information, or to report on the user interactions. The server, upon receipt of this information, may analyse it in the manner described above.

Therefore, while the server has been described as a distinct entity to the user equipment, it will be apparent that some functionality described as part of the server may be included in the user equipment. Alternatively or additionally, the functionality of the server may be spread amongst different server entities, for example the provision of webpages may be controlled by a different entity to that analysing the user interaction data. Consequently, it will be apparent that the provision of the steps of the user interaction, and the analysis of the user interaction data may be performed by any suitable data resource, whether this be located on a remote server, or within the user equipment, or a combination of the two.

The user interactions may not be limited to visual interactions (i.e. through graphical user interfaces), and may contain, or may be exclusively, audio or tactile in nature. For example the user interactions may be provided as a part of an Interactive Voice Response (IVR) or TouchTone telephone system, or through a tactile interface for the sight impaired.

In the embodiments above, all of the steps in all of the categories for all of the sequences are analysed. However this may not necessarily be the case and only a subset of the steps/categories/sequences may be analysed at a time.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. The features of the claims may be combined in combinations other than those specified in the claims.

1. A computer implemented method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising:
determining interaction data indicative of user interactions provided by the data resource, the interaction data including resource data indicative of a respective interaction sequence, of said different interaction sequences, and a respective step, of said plurality of steps, included in said respective interaction sequence, and user data;
assigning user interactions to predefined categories based on the user data; and
determining a plurality of analytics values based on the resource data and the assigned categories, such that the determined analytics values are associated with a given category, interaction sequence and step, the analytics values being for use in improving user interactions with the user interface.

2. The computer implemented method of claim 1, where the user interface comprises a graphical user interface.

3. The computer implemented method of claim 1, wherein for at least one user interaction, only some of the steps of an interaction sequence are provided by the data resource, and for at least one further user interaction, all of the steps of an interaction sequence are provided by the data resource.

4. The computer implemented method of claim 1, comprising identifying, for a given category, interaction sequence and step, a number of user interactions of the given category for which the given step of the given interaction sequence was the last step provided in the user interaction, whereby to determine the analytics value associated with the given category, interaction sequence and step.

5. The computer implemented method of claim 1, comprising identifying, for a given category, interaction sequence and step, a number of user interactions of the given category for which the given step of the given interaction sequence was followed by at least one further step of the given interaction sequence, whereby to determine the analytics value associated with the given category, interaction sequence and step.

6. The computer implemented method of claim 1, comprising identifying, for a given category, interaction sequence and step, a ratio of a number of user interactions of the given category for which the given step of the given interaction sequence was the last step provided in the user interaction, to a number of user interactions of the given category for which the given step of the given interaction sequence was followed by at least one further step of the given interaction sequence, whereby to determine the analytics value associated with the given category, interaction sequence and step.

7. The computer implemented method of claim 6, comprising classifying user interactions as successful or unsuccessful based on the steps provided in the user interaction.

8. The computer implemented method of claim 7, comprising identifying, for a given category and interaction sequence, a benefit value associated with the user interactions classified as successful.

9. The computer implemented method of claim 8, wherein the benefit value is based on one or more of:
a number of successful user interactions;
revenue generated by the successful user interactions;
input provided by a user during a successful user interaction.

10. The computer implemented method of claim 8, comprising multiplying the ratio by the benefit value.

11. The computer implemented method of claim 1, wherein the categories are defined based characteristics of the user and/or a system used by the user to interact with the user interface.

12. The computer implemented method of claim 1, wherein the categories are defined based on one or a combination of:
whether the user is a returning user or a new user;
location information relating to the user;
demographic information relating to the user;
a browsing history of the user;
a usage history of the user;
a time at which the user interaction occurred;
computer software used by the user; and
computer hardware used by the user.

13. The computer implemented method of claim 1, wherein at least one of the steps is present in two or more interaction sequences.

14. The computer implemented method of claim 1, wherein at least one user makes a plurality of said user interactions in a given session.

15. The computer implemented method of claim 1, comprising comparing the analytics values and identifying at least one of the steps of an interaction sequence associated with a given category based on the magnitude of the associated analytics values.

16. The computer implemented method of claim 1, comprising:
receiving a modification proposal, the modification proposal identifying one or more of said steps of one or more interaction sequences associated with one or more of said categories;
calculating a combined analytics value based on the analytics values associated with the identified one or more steps, one or more interaction sequences and one or more categories.

17. The computer implemented method of claim 16, comprising:
receiving a modification value associated with the modification proposal;
multiplying the combined analytics value by the modification value.

18. The computer implemented method of claim 1, wherein the user interface provided by the data resource comprises a website provided by a server, and said steps comprise webpages generated using data provided by the server.

19. A system for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the system comprising a processor configured to:
determine interaction data indicative of user interactions provided by the data resource, the interaction data including resource data indicative of a respective interaction sequence, of said different interaction sequences, and a respective step, of said plurality of steps, included in said respective interaction sequence, and user data;
assign user interactions to predefined categories based on the user data; and
determine a plurality of analytics values based on the resource data and the assigned categories, such that the determined analytics values are associated with a given category, interaction sequence and step, the analytics values being for use in improving user interactions with the user interface.

20. A computer program product comprising a non-transitory computer-readable storage medium having computer readable instructions stored thereon, the computer readable instructions being executable by a computerized device to cause the computerized device to perform a method for use in improving user interactions with a user interface provided by a data resource, the data resource being configured to provide an interaction sequence during a user interaction with the user interface, the interaction sequence including a plurality of steps, the data resource being configured to provide different user interaction sequences during different user interactions, the method comprising:
determining interaction data indicative of user interactions provided by the data resource, the interaction data including resource data indicative of a respective interaction sequence, of said different interaction sequences, and a respective step, of said plurality of steps, included in said respective interaction sequence, and user data;
assigning user interactions to predefined categories based on the user data; and
determining a plurality of analytics values based on the resource data and the assigned categories, such that the determined analytics values are associated with a given category, interaction sequence and step, the analytics values being for use in improving user interactions with the user interface.
